(19) United States
(12) Patent Application Publication
(10) Pub. No.: US 2014/0108162 A1
(43) Pub. Date: Apr. 17, 2014

(54) PREDICTING PERFORMANCE OF AN ONLINE ADVERTISING CAMPAIGN

(71) Applicant: MICROSOFT CORPORATION, Redmond, WA (US)

(72) Inventors: NITIN KUMAR, BELLEVUE, WA (US); SERTAN ALKAN, BELLEVUE, WA (US)

(73) Assignee: MICROSOFT CORPORATION, REDMOND, WA (US)

(21) Appl. No.: 13/654,205

(22) Filed: Oct. 17, 2012

(51) Int. Cl. G06Q 30/02

(52) U.S. Cl. 705/14.72

(57) ABSTRACT

Predicting a performance level of an online advertisement campaign, which is based on an advertising keyword, includes various method, systems, and other components. For example, the advertising keyword may be selected during a process in which the advertising campaign is being created. In response, predicted performance levels are provided that quantify how well the advertisement campaign may perform if certain advertisement audiences are targeted.

### BACKGROUND

An online advertising system allows an advertiser to create an online advertising campaign, which the advertising system follows when serving online advertisements. The advertiser is typically allowed to specify various instructions when creating the advertising campaign. For example, the advertiser might specify or design advertisements and advertising content that are to be served, and the advertiser often designates keywords to be used to invoke or trigger serving of an advertisement. In addition, the advertiser can sometimes specify certain audience characteristics or traits that the advertiser wants to target, such as demographic traits (e.g., gender, age, etc.) location, device, and the like.

### SUMMARY

In brief and at a high level, this disclosure describes, among other things, predicting a performance level of an online advertisement campaign, which is based on an advertising keyword. The advertising keyword may be selected or retrieved during a process in which the advertising campaign is being created. In response, predicted performance levels may be provided that quantify how well the advertisement campaign may perform if certain advertising audiences are targeted.

This summary provides an overview of the disclosure and introduces a selection of concepts that are further described below in the detailed-description section. This summary is not intended to identify key features or essential features of the claimed subject matter, nor is it intended to be used as an aid in isolation to determine the scope of the claimed subject matter.

### BRIEF DESCRIPTION OF THE DRAWINGS

Illustrative embodiments of the present invention are described in detail below with reference to the attached drawing figures, which are incorporated herein by reference, wherein:

FIG. 1 depicts an exemplary computing device in accordance with an embodiment of the present invention;

FIG. 2 depicts an exemplary computing environment in accordance with an embodiment of the present invention;

FIGS. 3a, 3b, 4a, 4b, and 4c depict various screenshots in accordance with embodiments of the present invention; and

FIGS. 5 and 6 depict flow diagrams that outline respective methods in accordance with embodiments of the present invention.

### DETAILED DESCRIPTION

The subject matter of select embodiments of the present invention is described with specificity herein to meet statutory requirements. But the description itself is not intended to define what is regarded as an invention; rather the claims define the invention. The claimed subject matter might be embodied in other ways to include different elements or combinations of elements similar to the ones described in this document, in conjunction with other present or future technologies. Terms should not be interpreted as implying any particular order among or between various steps or elements herein disclosed unless and except when the order of individual steps is explicitly stated.

An embodiment of the present invention is directed to providing a predicted performance level of an online advertisement campaign. For example, an advertising keyword is received by an advertising system when the advertising campaign is being created. In response, the advertising system provides a plurality of predicted performance metrics. Each of the predicted performance metrics quantifies a predicted performance level of a respective advertising campaign based on a targeting option.

In this description, an “advertising keyword” is a keyword that invokes or prompts an online advertising system to serve an online advertisement. For example, a keyword might prompt service of an advertisement when the keyword is parsed from web-page content or is specified as a search term. In an embodiment of the present invention, an advertising keyword is specified or identified during the process of creating an advertising campaign with an advertising system.

In this description, an “advertising target-audience category” generally describes and classifies a plurality of advertising target-audience options, which more specifically describe an advertising audience or a context in which an advertisement is served. An advertising target-audience category may encompass personal traits of a target audience, such as a demographic category of information (e.g., age, gender, etc.). That is, one exemplary advertising target-audience category includes gender and age. In addition, an advertising target-audience category may describe a context in which an advertisement is served, such as location, device type, time and day, and the like. As such, other exemplary advertising target-audience categories include location, device or device type, and time/day of week.

In this description, an “advertising target-audience option” describes specific options that are included within an advertising target-audience category and that describe a particular attribute within the category. For example, if an advertising target-audience category includes gender, then advertising target-audience options include male and female. Similarly, if an advertising target-audience category includes ages, then advertising target-audience options might include exemplary ages ranges of 0-18, 19-21, 21-29, 20-25, and the like.

In one embodiment of the present invention, a default set of advertising target-audience categories and a default set of advertising target-audience options are used by an advertising system when processing information during the creation of the advertising campaign. That is, the advertisement system may receive an advertising keyword that is identified as relevant to the advertising campaign. In response, the advertisement system may generate and provide predicted performance levels of the default target-audience options (e.g., male and female, age groups, locations, device types, etc.). In this respect, the advertisement system provides predicted performance levels of various campaigns, each of which is based on a default target option. In another embodiment of the present invention, one or more advertising target-audience categories and/or advertising target-audience options are expressly received by the advertising system (e.g., specified by the advertiser) when an advertising campaign is being created. In a further embodiment of the present invention, predicted performance levels of target-audience options (e.g., male and female) are provided when a more general target-audience category (e.g., gender) is designated.

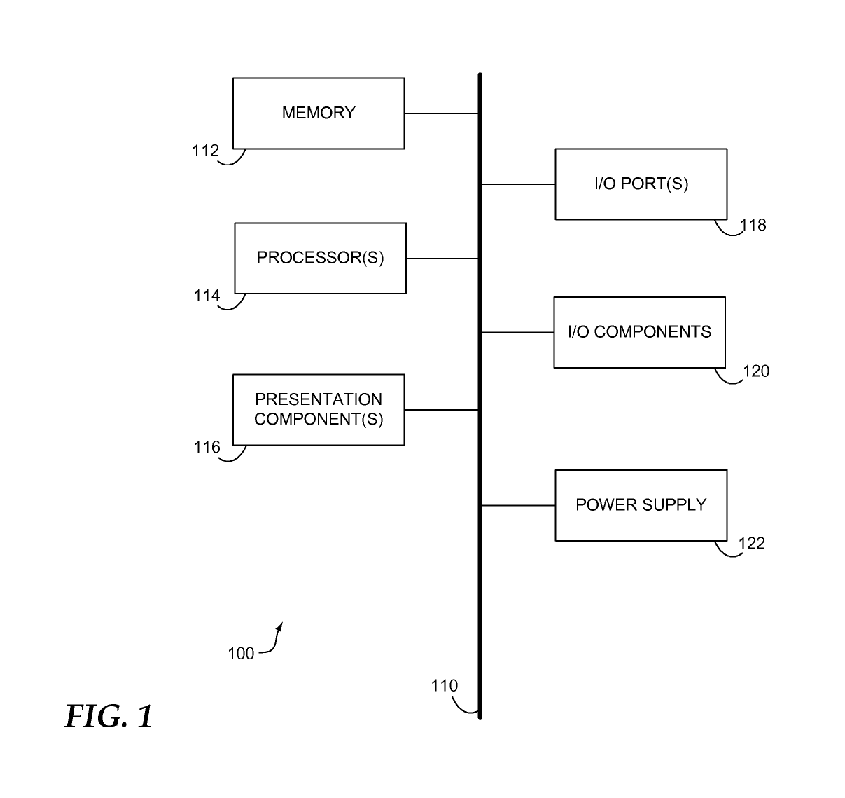

Referring now to FIG. 1, an exemplary operating environment for implementing embodiments of the present invention is shown and designated generally as computing device 100. Computing device 100 is but one example of a suitable computing environment and is not intended to suggest any limitation as to the scope of use or functionality of invention embodiments. Neither should the computing device 100 be interpreted as having any dependency or requirement relating to any one or combination of components illustrated. Computing device 100 may include a variety of different computing devices, such as a desktop, laptop, tablet, netbook, notebook, server, smartphone, and the like.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise computer storage media or communications media. Examples of computer storage media include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other storage medium that can be used to encode desired information and be accessed by computing device 100.

As such, an embodiment of the present invention is directed to a computer-readable storage memory having instructions stored thereon that, when executed by a computing device, perform a method including various operations. Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. Exemplary input components include a microphone, keyboard, touch screen, mouse, and the like.

I/O ports 118 allow computing device 100 to be logically coupled to other devices including I/O components 120, some of which may be built in. Illustrative components include a microphone, joystick, game pad, satellite dish, scanner, printer, wireless device, etc.

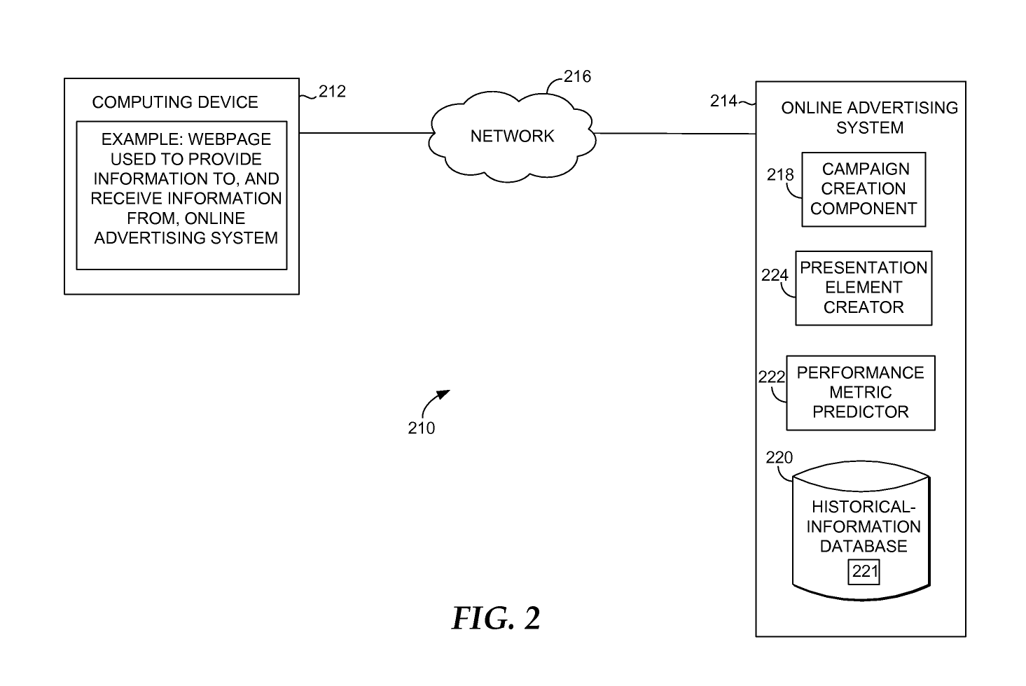

Referring now to FIG. 2, an exemplary operating environment 210 is depicted in which embodiments of the present invention may be carried out. Environment 210 includes a computing device 212 that is in communication with (i.e., networked) with an online advertising system 214 by way of a network 216 (e.g., network that leverages the Internet).

In an embodiment of the present invention, computing device 212 is a client computing device that facilitates a process of creating an online advertising campaign. That is, computing device 212 may be used to submit to online advertising system 214 information (e.g., keyword(s), website information, ad content, URL, target parameters, etc.) used to create the online advertising campaign. In addition, online advertising system 214 includes various components that receive information from computing device 212 and other sources and that execute campaign-creation operations. For example, online advertising system 214 includes a campaign-creation component 218 that interfaces with computing device 212 during the campaign-creation process to request information from, and submit information to, computing device 212.

Online advertising system 214 may receive a variety of different information from computing device 212 and from other sources when an advertising campaign is being created. For example, advertising system 214 receives login information that allows advertising system to either set up an advertising account or retrieve existing account information. In the process of either setting up an account or retrieving account information, advertising system 214 may receive an advertiser name (e.g., business-entity name), product information, a URL, advertisement content, and the like. In one embodiment, campaign-creation component 218 operates to receive and compile information throughout the campaign creation process. For example, advertising system 214 may provide some type of fillable form (e.g., web form) that is transmitted to computing device 212 when computing device 212 navigates to a website of the advertising system 214. Using the fillable form, computing device 212 may provide various information to advertising system 214.

When an advertising campaign is being created, advertising system 214 also receives one or more advertising keywords. In one embodiment of the present invention, advertising system 214 may receive an advertising keyword that is expressly designated as such from computing device 212. For example, campaign-creation component 218 may receive an advertising keyword that is designated as such when provided from computing device 212 via a web form. In another embodiment, advertising system 214 may receive other types of information from computing device 212 that is input into the web form and that advertising system 214 deems an advertising keyword. For example, advertising system 214 might receive a business name from computing device 212 that is not expressly designated as an advertising keyword when provided in the web form but that advertising system 214 deems an advertising keyword.

Advertising system 214 may receive advertising keywords from other sources as well. For example, advertising system 214 may receive a URL designation from computing device 212. As such, advertising system 214 may parse content located at the URL designation to retrieve advertising keywords. In addition, advertising system 214 might search a historical advertising keywords to locate previously used advertising keywords, which are relevant to information received from computing device 212.

Advertising system 214 may receive other information from computing device 212 when an advertising campaign is being created, such as advertising target-audience categories and advertising target-audience options. In one embodiment of the present invention, advertising system 214 receives from computing device 212 an indication that an advertising campaign will include target a particular advertising audience within a particular advertising target-audience category. As indicated in other portions of this description, exemplary advertising target-audience categories include demographic profile (e.g., gender, age, etc.); rendering device and device type; location to which an advertisement will be served; and time and day at which an advertisement is to be served.

Advertising system 214 may receive from computing device 212 a location targeting option in a variety of ways when an advertising campaign is being set up. For example, advertising system 214 may receive a city designation, zip-code designation, state designation, regional designation (e.g., Midwest), country designation, continent designation, and the like.

In another embodiment of the present invention, advertising system 214 receives location targeting options that includes a geographical boundary. For example, a geographical boundary may be drawn on a map displayed on computing device 212 and may be transmitted to advertising system 214. In addition, advertising system 214 may receive map parameters or some other indication of the scope of a map presented on computing device 212. That is, tools running on computing device 212 may allow zooming into a map to display a smaller geographical boundary or zooming out from a map to display a larger geographical boundary. Accordingly, advertising system 214 may receive an indication of a geographical boundary presented by a map displayed by computing device 212. In an embodiment of the present invention, the geographical boundary represents an audience category to be targeted by an advertising campaign and includes a set of targeting options (e.g., cities, neighborhoods, zip codes, and the like).

Database 220 stores various information 221. For example, database 220 stores information related to advertising keywords. Information related to advertising keywords includes any information that may be used to assess or evaluate the likelihood that an advertisement, which is served as the result of a particular advertising keyword, will result in an action (e.g., advertisement click, advertisement conversion, etc.).

In an embodiment of the present invention, information stored in database 220 includes search-query logs of search queries executed on a keyword. Search-query logs store the searched keyword in association with details describing the context of a search query, such as profile information of the user; time and day; client device and device type; location from which query is sent; and the like. In addition, search-query logs record actions that are taken when search results are served, such as a requesting a website, viewing an advertisement, clicking an advertisement, buying a product, submitting a subsequent query, and the like.

In another embodiment of the present invention, information stored in database 220 includes information describing previously implemented advertising campaigns. For example, database 220 may record the advertising keyword, number of impressions, clicks, and conversions; profile of users who view, click, and take an action after clicking on an advertisement; location to which advertisements were served; time and day when advertisements were served; client devices and device types to which advertisements were served; and the like.

The information in database 220 may be received and stored separately. Alternatively, the information in database 220 may be compiled and organized, such as by keyword. That is, all of the information related to a particular advertising keyword may be aggregated and filtered to remove irrelevant information. Relevant extracted information might then be organized into a structure (e.g., table) that allows for subsequent processing and analysis. For example, information related to a keyword may be stored in a row of the table, such that each column represents a respective input that is useful to predict the likelihood that an advertisement, which is served as the result of the advertising keyword, will result in an action.

In one embodiment of the present invention, information 221 that is collected and stored in database 220 and that is deemed relevant to a keyword includes values defining advertising target-audience categories and values defining advertising target-audience options. For example, for a given keyword, database 220 might store information describing how the keyword relates to various user demographics, locations, devices, device types, time of day, day of the week, and the like. In addition, database 220 might store a number of advertisements served as a result of the keyword; a number of advertisements that were served as a result of a keyword and that were clicked; and a number of advertisements that were served as a result of a keyword and that resulted in some other action (e.g., conversion, purchase, reservation, etc.). These and other types of information might be collected from the previously implemented advertising campaigns and from the search-engine logs.

Online advertising system 214 also includes a performance-metric predictor 222. Performance-metric predictor 222 processes the information stored in database 220 to quantify an extent to which an advertising campaign based on an advertising keyword is predicted to achieve advertising objectives. In this description, these values calculated by performance-metric predictor 222 are referred to as “predicated performance metrics.” The performance-metric predictor 222 may be programmed to analyze various advertising objectives or success metrics. For example, advertising-campaign success or performance may be based on advertisement clicks, advertisement conversions, or a combination thereof, such that performance-metric predictor 222 is programmable to analyze each and all of these metrics.

In an embodiment of the present invention, performance-metric predictor 222 might calculate a probabilistic model depending on a given keyword and one or more other values. For example, performance-metric predictor 222 might calculate a predicated performance metric based on a given keyword and a target option (e.g., location, demographic, etc.) or a combination of target options. For a keyword, performance-metric predictor 222 might calculate several different predicated performance metrics based on various sets of one or more categories and targets. For example, if a performance-metric predictor 222 is generating predicated performance metrics for a keyword to evaluate locations within a geographic boundary, modeler might generate a value for every city, zip code, neighborhood, etc. within the geographic boundary. In addition, modeler might generate a value for combinations of targets, such as a city and a device, or a city, a device, and a time of day.

An example of a statistical strategy applied by performance-metric predictor 222 includes a Naïve Bayes Classifier in which the model is based on the cumulative probabilities of each individual feature value and those of multiple features together for each action in logs. In addition, performance-metric predictor 222 is programmed to be normalized across a keyword and/or across all keywords, such that predicated performance metrics are comparable despite the fact that different target values may be taken into consideration. In a further embodiment, performance-metric predictor 222 is programmed to weight calculations based on an amount of, and quality of, information available for a given keyword.

Performance-metric predictor 222 may be programmed to run at various times. For example, performance-metric predictor 222 may run at regular intervals and store results to database 220 so that predicated performance metrics are readily retrievable. In addition, performance-metric predictor 222 may run when relevant information is received that is related to a keyword (e.g., when database 220 is updated with recently compiled search-query logs). In addition, performance-metric predictor 222 may generate predicated performance metrics in response to a request from campaign creator component 218 or computing device 212.

In a further embodiment, advertising system 214 includes a presentation-element creator 224 that creates presentation elements designed to present predicated performance metrics. That is, as previously described performance-metric predictor 222 calculates predicated performance metrics, which might be stored in database 220; however, presentation-element creator 224 designs a presentation element that is transmitted to computing device 212 engaged in the process of creating the online advertising campaign.

In one embodiment, a presentation element includes a value, such as a percentage, ranking, score, etc., and the like. The presentation element may include other graphical, tactile, and/or audible indications that a particular advertisement campaign is predicted to perform well or perform poorly. The presentation element is programmed to update a webpage (e.g., web form) being viewed on computing device 212. For example, computing device 212 might be presenting information related to an advertising campaign, which is being created. Once advertising system 214 has received advertisement-campaign information and retrieved relevant predicated performance metrics, the presentation element is transmitted to the computing device 212 to suggest how well the advertisement campaign will perform.

The various components of advertising system 214 are illustrated as separate components for exemplary purposes. However, in other embodiments, one or more of the components may be combined into a single component. For example, presentation-element creator 224 might be a component that operates as part of campaign-creation component 218.

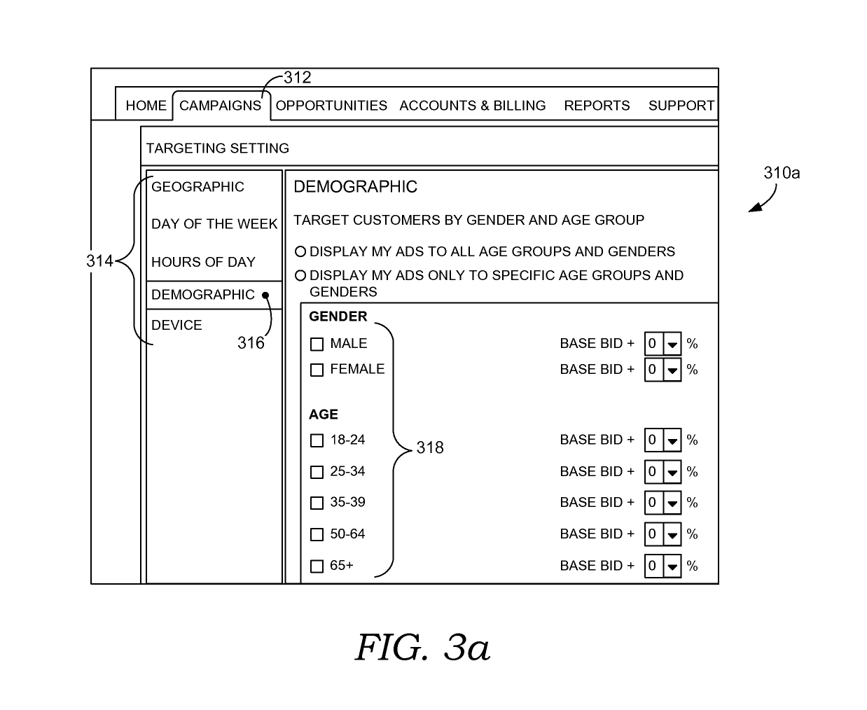

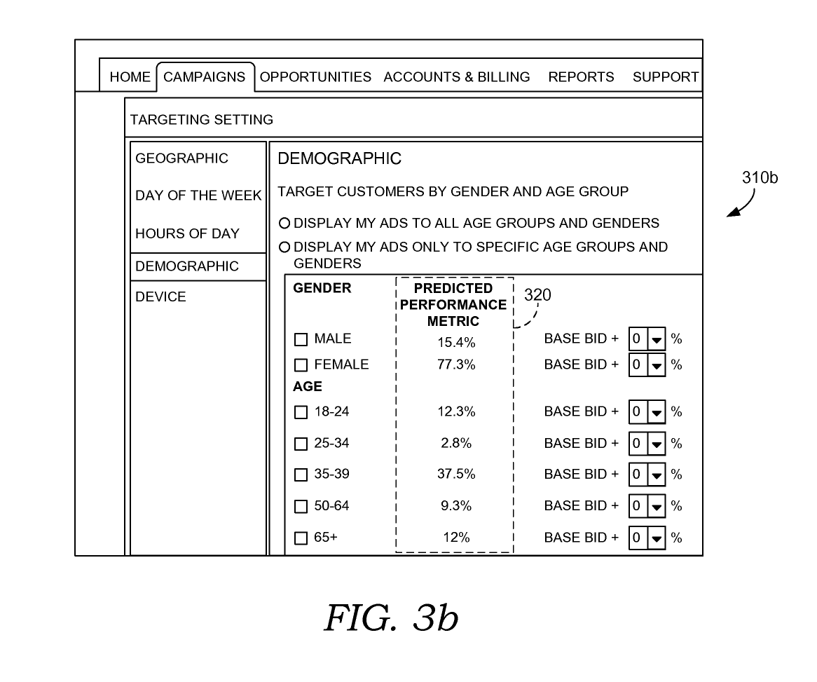

Referring briefly to FIGS. 3a and 3b for illustrative purposes, screen shots 310a and 310b are depicted that might be presented by computing device 212. For example, screenshot 310a may be presented by computing device 212 during a process for creating an advertising campaign. Screenshot 310a includes a “campaigns” tab 312 that has been selected and that presents various targeting options 314. As indicated, the “demographic” targeting category 316 has been selected and various demographic targeting options 318 are presented.

Although not explicitly depicted in screenshot 310a, an advertising keyword might be specified in another portion of the interface represented by screenshot 310a. In addition, advertising system may extract keywords from other information associated with the advertising account. As indicated in other portions of this description, the advertising keyword is received by advertising system 214, predicated performance metrics are generated, and a presentation element is transmitted to computing device 212. As such, screenshot 310b (FIG. 3b) illustrates a modified version of screenshot 310a (FIG. 310a) that has been updated based on predicated performance metrics. In FIG. 3b, predicated performance metrics 320 are presented for each of the demographic target options among the age groups and gender. As such, the advertising system 214 provides information in the course of the campaign-creation process that suggests which targeting options are more likely to achieve advertising objectives (e.g., advertisement clicks or conversions).

In another embodiment, the presentation element may include a map or a map enhancement that presents predicated performance metrics and that updates a map presented on computing device 212. As previously described, when selecting a target-audience location to be used in an advertising campaign, a map with a zoom in/out feature may be used to designate a target location boundary. As such, presentation-element creator 224 might generate an element, which is transmitted to computing device 212 to update the map and present relevant predicated performance metrics. For example, the presentation element may include values (e.g., percentages, scores, rankings, etc.) that are presented to overlay a respective target (e.g., city, zip, etc.). Other types of presentation elements may be used to enhance a map, such as colors, graphical icons, and the like.

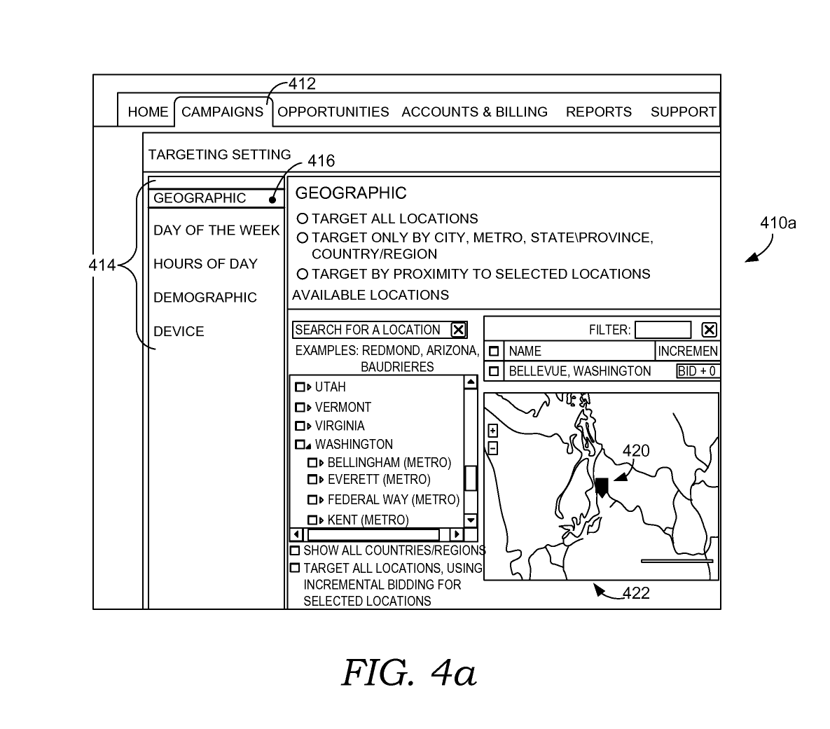

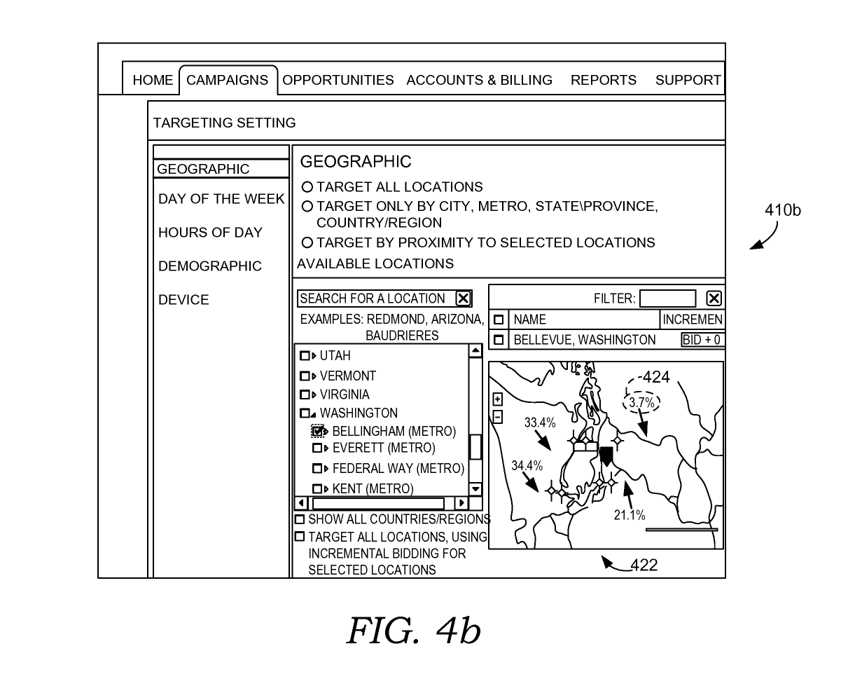

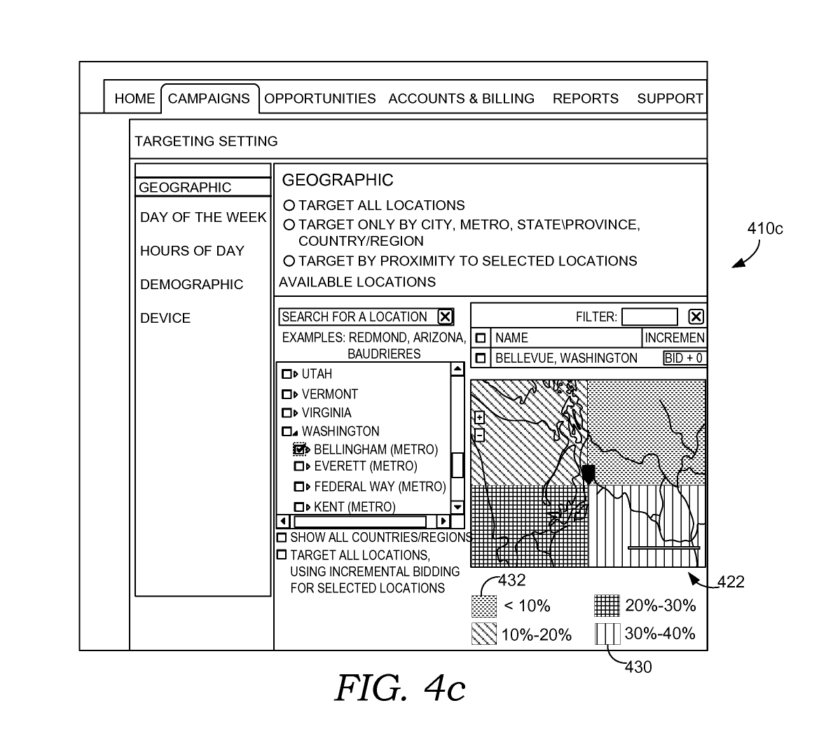

Referring briefly to FIGS. 4a and 4b for illustrative purposes, screen shots 410a and 410b are depicted that might be presented by computing device 212. For example, screenshot 410a may be presented by computing device 212 during a process for creating an advertising campaign. Screenshot 410a includes a “campaigns” tab 412 that has been selected and that presents various targeting options 414. As indicated, the “geographic” targeting category 416 has been selected and various location targeting options are presented. The interface depicted by screenshot 412a allows location targeting options to be searched for, to be checked in a list, and to be located on a map by zooming in/out. Icon 420 is positioned on map 422 to represent a particular location on the map 422.

Although not explicitly depicted in screenshot 410a, an advertising keyword might be specified in another portion of the interface represented by screenshot 410a. In addition, advertising system may extract keywords from other information associated with the advertising account. As indicated in other portions of this description, the advertising keyword is received by advertising system 214, predicated performance metrics are generated, and a presentation element is transmitted to computing device 212. As such, screenshot 410b (FIG. 4b) illustrates a modified version of screenshot 410a (FIG. 410a) that has been updated based on predicated performance metrics. In FIG. 4b, a predicated performance metric (e.g., percentage value 424) has been provided for each of the location target options among the geographic boarder represented in map 422. The location target options are identified by a respective arrow positioned adjacent to each metric. As such, the advertising system 214 provides information in the course of the campaign-creation process that suggests which targeting options are more likely to achieve advertising objectives (e.g., advertisement clicks or conversions).

Although FIGS. 3b and 4b depict predicated performance metrics as percentages, a presentation element may include various other forms. For example, a graphical icon (e.g., thumbs up or thumbs down) could be used to suggest a predicted performance. In addition, a color-coding scheme could represent respective metric values (e.g., green signifies relatively high metric and red signifies relatively low metric).

Depicting an exemplary embodiment, FIG. 4c illustrates screenshot 410c that includes a modified version of screenshot 410a (FIG. 4a) and that has been updated based on predicated performance metrics. In FIG. 4c, predicated performance is illustrated by way of a pattern-coding scheme for location target options among the geographic boarder represented in map 422. The location target options are identified by a respective pattern-coded outline representing each metric. The pattern-coded outlines include rectangles for illustrative purposes, however, any shape of outline might be used inkling shapes having irregular borders. The pattern-coding scheme is defined directly underneath map 422, such that each pattern represents a respective metric value. Although black-and-white patterns are depicted in FIG. 4c for illustrative purposes, in another embodiment color coding is used. For example, pattern 430 might color-coded green, whereas pattern 432 might be color-coded red. As such, the advertising system 214 provides information in the course of the campaign-creation process that suggests which targeting options are more likely to achieve advertising objectives (e.g., advertisement clicks or conversions). By providing visual indications using the pattern-coding scheme, advertising campaign targeting options can be quickly evaluated.

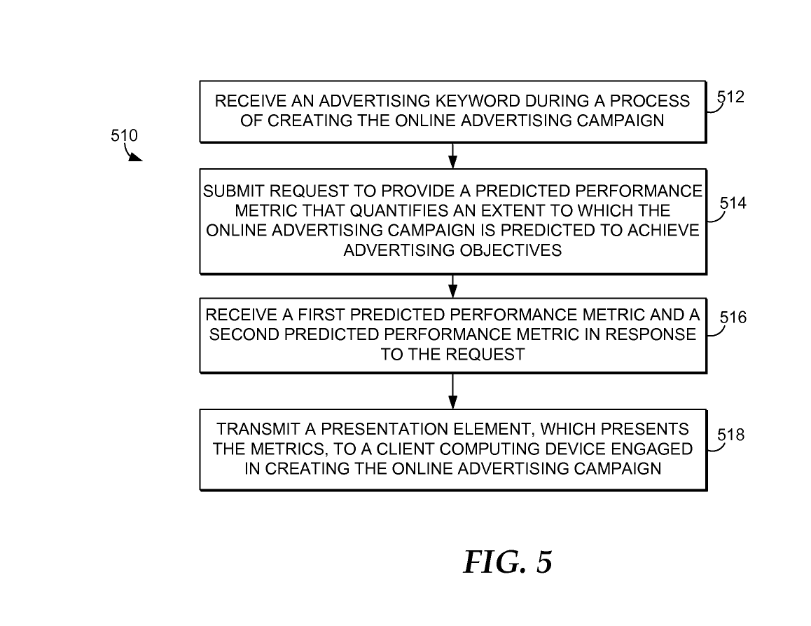

Referring now to FIG. 5, a flow diagram depicts a method 510 that may be carried out in accordance with an embodiment of the present invention. Steps of method 510 may be stored on computer-readable media as computer-executable instructions that, when executed by a computing device, perform a method of predicting a performance level of an online advertising campaign. In describing method 510, reference may also be made to FIGS. 2, 3a, 3b, 4a, and 4b.

Method 510 includes at step 512 receiving an advertising keyword during a process of creating the online advertising campaign. For example, campaign creation component 218 might receive an advertising keyword from computing device 212. The advertising keyword may be expressly input into a web form running on computing device 212 or may be extracted from other types of information (e.g., business name) input into the web form. In addition, the keyword may be parsed from content of a website located at a URL provided in the web form.

At step 514, a request is submitted to provide a predicted performance metric that quantifies an extent to which the online advertising campaign is predicted to achieve advertising objectives. For example, campaign creation component 218 might send a request to another component of advertising system 214 that requests the other component to provide the metric. In one embodiment, a request is sent to performance metric predictor 222, which analyzes the information 221 stored in database 220 to calculate the metric. In another embodiment, a metric is stored in information 221 of database 220 in association with the advertising keyword, and the request is a query submitted against information 221.

Step 516 includes receiving a first predicted performance metric and a second predicted performance metric in response to the request. The first predicted performance metric quantifies a predicted achievement of a first online advertising campaign, which is based on the advertising keyword and a first target-audience option. The second predicted performance metric quantifies a predicted achievement of a second online advertising campaign, which is based on the advertising keyword and a second target-audience option. For example, metrics might be provided that quantify predicted achievements of a first advertising campaign based on the advertising keyword and a first device type (e.g., mobile) and a second advertising campaign based on the advertising keyword and a second device type (e.g., tablet).

At step 518, a presentation element is transmitted to a client computing device that is engaged in the process of creating the online advertising campaign, wherein the presentation element is designed to present the first predicted performance metric and the second predicted performance metric. For example, the presentation element might be sent to computing device 212.

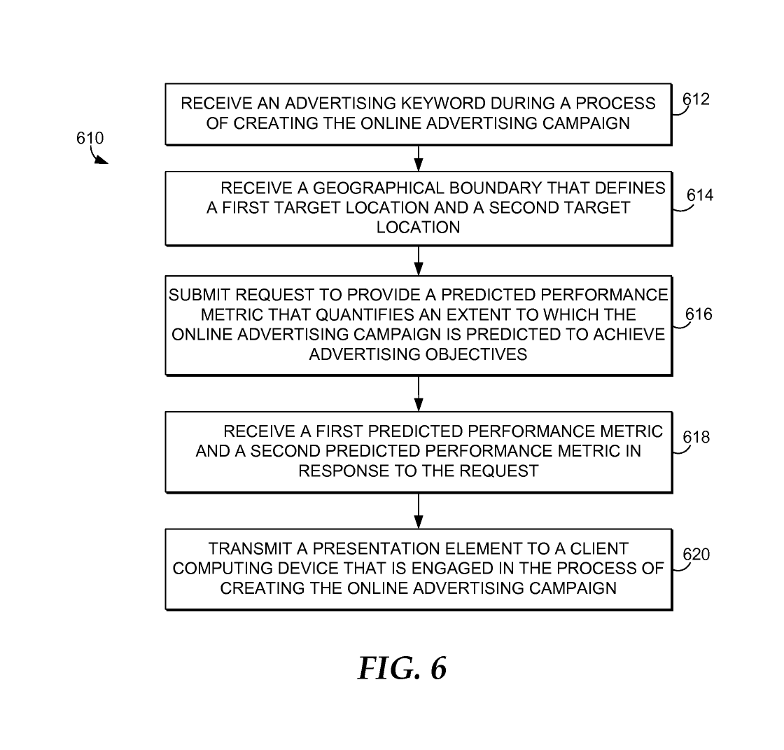

Referring now to FIG. 6, a flow diagram depicts a method 610 that may be carried out in accordance with an embodiment of the present invention. Steps of method 610 may be stored on computer-readable media as computer-executable instructions that, when executed by a computing device, perform a method of predicting a performance level of an online advertising campaign. In describing method 610, reference may also be made to FIGS. 2, 3a, 3b, 4a, and 4b.

Method 610 includes at step 612 receiving an advertising keyword during a process of creating the online advertising campaign. For example, campaign creation component 218 might receive an advertising keyword from computing device 212. The advertising keyword may be expressly input into a web form running on computing device 212 or may be extracted from other types of information (e.g., business name) input into the web form. In addition, the keyword may be parsed from content of a website located at a URL provided in the web form.

Method 610 also includes at step 614 receiving a geographical boundary during the process of creating the online advertising campaign, wherein the geographical boundary defines a first target location and a second target location. For example, using one or more tools depicted in FIG. 4a, a geographical boundary (e.g., map parameters, city, state, and the like) may be transmitted to, and received by, advertising system 214. In the example provided in FIG. 4a, map 422 may define a first city or town and a second city or town, which are target locations.

Step 616 includes submitting a request to provide a predicted performance metric that quantifies an extent to which the online advertising campaign is predicted to achieve advertising objectives. The request includes the advertising keyword and the geographical boundary. For example campaign creation component 218 might combine the advertising keyword and the geographical boundary (or target locations within the boundary) into a request and send the request to another component of advertising system 214. In one embodiment, a request is sent to performance metric predictor 222, which analyzes the information 221 stored in database 220 to calculate the metric. In another embodiment, a metric is stored in information 221 of database 220 in association with the advertising keyword, and the request is a query submitted against information 221.

At step 618 a first predicted performance metric and a second predicted performance metric are received in response to the request. The first predicted performance metric quantifies a predicted achievement of a first online advertising campaign, which is based on the advertising keyword and a first target location. The second predicted performance metric quantifies a predicted achievement of a second online advertising campaign, which is based on the advertising keyword and a second target location.

Step 620 includes transmitting a presentation element to a client computing device that is engaged in the process of creating the online advertising campaign. The presentation element is designed to enhance a map presented by the client computing device in order to present the first predicted performance metric and the second predicated performance metric. For example, a presentation element may be designed to enhance map 422 by presenting metric values, as depicted in FIG. 4b.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

1. Computer-readable media storing computer-executable instructions that, when executed by a computing device, cause the computing device to perform a method of predicting a performance level of an online advertising campaign, the method comprising:
receiving an advertising keyword during a process of creating the online advertising campaign;
submitting a request to provide a predicted performance metric that quantifies an extent to which the online advertising campaign is predicted to achieve advertising objectives;
receiving a first predicted performance metric and a second predicted performance metric in response to the request,
wherein the first predicted performance metric quantifies a predicted achievement of a first online advertising campaign, which is based on the advertising keyword and a first target-audience option, and
wherein the second predicted performance metric quantifies a predicted achievement of a second online advertising campaign, which is based on the advertising keyword and a second target-audience option; and
transmitting a presentation element to a client computing device that is engaged in the process of creating the online advertising campaign, wherein the presentation element is designed to present the first predicted performance metric and the second predicted performance metric.

2. The computer-readable media of claim 1, wherein the first target-audience option and the second target-audience option describe different advertisement-rendering devices.

3. The computer-readable media of claim 1, wherein the first target-audience option and the second target-audience option describe different locations.

4. The computer-readable media of claim 3 further comprising, receiving an advertising target-audience category during the process of creating the online advertising campaign, wherein the target-audience category includes a geographical boundary that defines the first target-audience option and the second-target audience option.

5. The computer-readable media of claim 4, wherein the presentation element includes a map-enhancement element designed to enhance a map presented by the client computing device in order to present the first predicted performance metric and the second predicated performance metric.

6. The computer-readable media of claim 1, wherein the first target-audience option and the second target-audience option each describes a group having a respective set of demographic characteristics.

7. The computer-readable media of claim 1, wherein the first target-audience option and the second target-audience option describe different time instances for serving an advertisement, different days of the week for serving the advertisement, or a combination of the different time instances and different days of the week.

8. The computer-readable media of claim 1, wherein the first predicted performance metric and the second predicted performance metric are generated based on historical information related to the advertising keyword.

9. The computer-readable media of claim 8, wherein the historical information includes advertisement impressions, advertisement clicks, advertisement conversions, or a combination thereof, of another advertising campaign that is based on the advertising keyword.

10. The computer-readable media of claim 8, wherein the historical information includes search-engine logs of search-engine queries, which include the advertising keyword.

11. The computer-readable media of claim 1, wherein a third predicted performance metric is received in response to the request, and wherein the third predicted performance metric quantifies a predicted achievement of a third online advertising campaign, which is based on the advertising keyword, the first target-audience option, and a third target audience option.

12. The computer-readable media of claim 1, wherein the advertising objectives include advertisement conversions.

13. An advertisement system for providing a predicted performance level of an advertising campaign, the system comprising:
a campaign-creation component that receives an advertising keyword during a process of creating the advertising campaign and that requests a predicated performance metric quantifying an extent to which the online advertising campaign is predicted to achieve advertising objectives;
a historical-information database that stores information related to the advertising keyword;
a performance-metric predictor that leverages a processing device to calculate a first predicted performance metric and a second predicted performance metric based on the information related to the advertising keyword; and
a presentation-element creator that creates a presentation element designed to present the first predicted performance metric and the second predicted performance metric, wherein the presentation element is transmitted to a client computing device engaged in the process of creating the online advertising campaign.

14. The system of claim 13,
wherein the information includes a first target-audience option and a second target-audience option,
wherein the first predicted performance metric quantifies a predicted achievement of a first online advertising campaign, which is based on the advertising keyword and a first target-audience option, and
wherein the second predicted performance metric quantifies a predicted achievement of a second online advertising campaign, which is based on the advertising keyword and a second target-audience option.

15. The system of claim 14, wherein the information stored in the historical-information database comprises advertisement impressions, advertisement clicks, advertisement conversions, or a combination thereof, of another advertising campaign that is based on the advertising keyword.

16. The system of claim 14, wherein the information stored in the historical-information database comprises search-engine logs of search-engine queries, which include the advertising keyword.

17. Computer-readable media storing computer-executable instructions that, when executed by a computing device, cause the computing device to perform a method of predicting a performance level of an online advertising campaign, the method comprising:
receiving an advertising keyword during a process of creating the online advertising campaign;
receiving a geographical boundary during the process of creating the online advertising campaign, wherein the geographical boundary defines a first target location and a second target location;
submitting a request to provide a predicted performance metric that quantifies an extent to which the online advertising campaign is predicted to achieve advertising objectives, the request including the advertising keyword and the geographical boundary;
receiving a first predicted performance metric and a second predicted performance metric in response to the request,
wherein the first predicted performance metric quantifies a predicted achievement of a first online advertising campaign, which is based on the advertising keyword and a first target location, and
wherein the second predicted performance metric quantifies a predicted achievement of a second online advertising campaign, which is based on the advertising keyword and a second target location; and
transmitting a presentation element to a client computing device that is engaged in the process of creating the online advertising campaign, wherein the presentation element is designed to enhance a map presented by the client computing device in order to present the first predicted performance metric and the second predicated performance metric.

18. The computer-readable media of claim 17, wherein the presentation element includes numerical values that represent the first predicted performance metric and the second predicated performance metric, and wherein the presentation element is designed to present each numerical value adjacent to a respective target location on the map.

19. The computer-readable media of claim 17, wherein receiving a geographical boundary includes receiving map parameters describing boundaries of the map rendered on the client computing device.

20. The computer-readable media of claim 17, wherein receiving a geographical boundary includes receiving a city designation, a state designation, a country designation, a zip code designation, a region designation, or a combination thereof.
